(19) United States
(12) Patent Application Publication
(10) Pub. No.: US 2023/0316319 A1
(43) Pub. Date: Oct. 5, 2023

(54) SYSTEM, METHOD, AND APPARATUS FOR OPTIMIZING RESOURCES

(71) Applicant: Nudge LLC, Columbus, NJ (US)

(72) Inventors: Rehan Khanzada, Columbus, NJ (US); Sanket Gajjar, Cedar Park, TX (US); Kunal Bavishi, Cranbury, NJ (US); Arsh Gajjar, Cedar Park, TX (US)

(73) Assignee: Nudge LLC, Columbus, NJ (US)

(21) Appl. No.: 17/710,987

(22) Filed: Mar. 31, 2022

(51) Int. Cl. G06Q 30/02

(52) U.S. Cl. CPC G06Q 30/0211; G06Q 30/0235

(57) ABSTRACT

Resource maximization allows entities to offer incentives via secure, seamless, and subtle suggestions, such as nudges, to optimize consumption of resources by consumers. One embodiment is the restaurant industry in which optimization includes turning restaurant tables during busy times or filling tables by incentivizing customers to come to the venue during slow times. Embodiments of this disclosure apply to any maximization of resources.

### FIELD OF THE DISCLOSURE

The present disclosure is generally related optimizing resources. More specifically, the disclosure relates to providing an incentive for consumers to modify their behavior to provide resources to others.

### BACKGROUND

It is not uncommon for patrons to linger at a venue, or establishment, such as a restaurant, even after the patrons are no longer actively engaged in the service, or activity of the venue, such as people lingering over a cup of coffee after they have finished eating at a restaurant. These customers occupy tables that could be used to serve new customers. Unfortunately, it can appear rude for restaurant personnel to ask, or suggest, lingering patrons leave the establishment.

### BRIEF SUMMARY OF THE DISCLOSURE

Often, resources associated with an entity such as a company, educational institution, park, entertainment venue, restaurant, or the like are not utilized in an optimal way by occupants, users, customers, consuming services or the like, as determined by an administrator of the site, or managing personnel. The present disclosure provides an improvement in resource optimization by incentives to consumers.

In accordance with an exemplary embodiment, the subject disclosure provides a computer-implemented method for optimizing resources. The method comprising: using at least one hardware processor for executing code for: accessing one or more incentives, the incentives including a benefit and a constraint providing one or more incentives to one or more consumers via an associated consumer device; receiving, via the associated consumer device, a response from the one or more consumers to the incentive; in response to receiving an affirmative response, determining compliance with the constraint by the consumer; in response to determining compliance with the constraint, providing the benefit to the consumer; and causing a representation of the provided benefit to be displayed on the consumer device.

The computer-implemented method further comprising determining a consumer interest level associated with the incentive. The computer-implemented method further comprising modifying the incentive based at least in part on the consumer interest level. The computer-implemented method further comprising: in response to receiving a negative response, from the one or more consumers to the incentive, generating a representation of the negative response; and causing the representation of the negative response to be displayed on a user device. The computer-implemented method further comprising determining non-compliance with the constraint; in response to determining non-compliance with the constraint, revoking the benefit to the consumer; and causing a representation of the revoked benefit to be displayed on a user device. The computer-implemented method further comprising: updating a status of a resource to available upon compliance with the constraint; and in response to the update, causing a representation of the status to be displayed at a user device. The computer-implemented method further comprising: correlating a time period for compliance with the constraint; and causing a representation of the time period to be displayed on a user device. The computer-implemented method further comprising: correlating a time period for compliance with the constraint; determining a decrease in the time period; and causing a representation of the decreasing time period to be displayed on a consumer device. The computer-implemented method further comprising: determining non-compliance with the constraint based at least in part on a time for compliance with the constraint expiring; in response to determining non-compliance with the constraint, revoking the benefit to the consumer; and causing a representation of the revoked benefit to be displayed on the consumer device. The computer-implemented method further comprising: correlating a time period for compliance with the constraint; causing a representation of the time period to be displayed on a consumer device; extending the time period for compliance with the constraint; and causing a representation of the extended time period to be displayed on a consumer device. The computer-implemented method wherein the one or more benefits comprise at least one of a discount, a coupon, an advertisement, one or more points, a membership, a discounted rate, cash back, or products. The computer-implemented method further comprising resource mapping to allow identification of each resource.

In accordance with another exemplary embodiment of the present disclosure, a system for optimizing resources is provided. The system comprising: one or more memories configured to store representations of data in an electronic form; and one or more processors, operatively coupled to one or more of the memories, the processors configured to access the data and process the data to: access one or more incentives, the incentives including a benefit and a constraint provide one or more incentives to one or more consumers via an associated consumer device; receive, via the associated consumer device, a response from the one or more consumers to the incentive; determine, in response to receiving an affirmative response, compliance with the constraint by the consumer; provide, in response to determining compliance with the constraint, the benefit to the consumer; and cause a representation of the provided benefit to be displayed on the consumer device.

The system includes processors further configured to access the data and process the data to: determine a consumer interest level associated with the incentive. The system includes processors further configured to access the data and process the data to: modify the incentive based at least in part on the consumer interest level. The system includes processors further configured to access the data and process the data to: generate, in response to receiving a negative response from the one or more consumers to the incentive, a representation of the negative response; and cause the representation of the negative response to be displayed on a user device. The system includes processors further configured to access the data and process the data to: determine non-compliance with the constraint; revoke the benefit to the consumer, in response to determining non-compliance with the constraint; and cause a representation of the revoked benefit to be displayed on a user device. The system includes processors further configured to access the data and process the data to: update a status of a resource to available upon compliance with the constraint; and cause a representation of the status to be displayed at a user device in response to the update. The system includes processors further configured to access the data and process the data to: determine non-compliance with the constraint based at least in part on a time for compliance with the constraint expiring; revoke the benefit to the consumer in response to determining non-compliance with the constraint; and cause a representation of the revoked benefit to be displayed on the consumer device.

In accordance with another exemplary embodiment, the present disclosure provides a non-transitory machine-readable medium having stored thereon machine-readable instructions executable to cause a machine to perform operations comprising: access one or more incentives, the incentives including a benefit and a constraint; provide one or more incentives to one or more consumers via an associated consumer device; receive, via the associated consumer device, a response from the one or more consumers to the incentive; determine, in response to receiving an affirmative response, compliance with the constraint by the consumer; provide, in response to determining compliance with the constraint, the benefit to the consumer; and cause a representation of the provided benefit to be displayed on the consumer device.

### BRIEF DESCRIPTION OF THE SEVERAL VIEWS OF THE DRAWINGS

The accompanying drawings, which are incorporated in and constitute a part of this specification, illustrate embodiments of the present disclosure and, together with the general description given above, and the detailed description given below, serve to explain the principles of the present disclosure.

The foregoing summary, as well as the following detailed description of the exemplary embodiments of the disclosure, will be better understood when read in conjunction with the appended drawings. For the purpose of illustrating the disclosure, there are shown in the drawings embodiments, which are presently preferred. It should be understood, however, that the disclosure is not limited to the precise arrangements and instrumentalities shown.

In the drawings:

FIG. 1 shows a network environment of an embodiment of the disclosure.

FIG. 2 shows an example of a process according to an embodiment of the disclosure.

FIG. 3 shows an example embodiment of the disclosure.

FIG. 4 shows another example embodiment of the disclosure.

FIG. 5 shows another example embodiment of the disclosure.

FIG. 6 shows another example embodiment of the disclosure.

FIG. 7 shows another example embodiment of the disclosure.

FIG. 8 shows an embodiment of resource optimization for consumers.

### DETAILED DESCRIPTION

Reference will now be made in detail to the various embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject disclosure in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout this disclosure, various aspects of the subject disclosure can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the present disclosure can be practiced without one or more of the specific features or advantages of a particular exemplary embodiment. In other instances, additional features and advantages may be recognized in certain embodiments that may not be present in all exemplary embodiments of the subject disclosure.

Embodiments of the disclosure will be described with reference to the accompanying drawings. Like numerals represent like elements throughout the several figures, and in which example embodiments are shown. However, embodiments of the claims may be embodied in many different forms and should not be construed as limited to the embodiments set forth herein. The examples set forth herein are non-limiting examples and are merely examples, among other possible examples.

For illustrative purposes, embodiments of this disclosure are described in relation to a restaurant environment. However, it should be apparent to those of skill in the art, that any suitable venue could be enhanced by the principles and embodiments described herein. Resource optimization between consumers is disclosed that facilitates maximization of use of resources by multiple consumers. Indeed, the systems methods and apparatus described herein apply to any environment that includes customers, consumers, or users whose behavior could be influenced with incentives.

Often resources associated with an entity such as a company, educational institution, restaurant, or the like are not occupied in an optimal way by occupants, users, customers, consuming services or the like, as determined by an administrator of the site. For example, a company may have multiple resources such as tables, computers, servers and other devices that may be utilized in a non-optimal way, resulting in excessive energy usage, waste of computer processing cycles, and/or a loss of monetary value by non-use or non-occupancy. Specifically, in scenarios where a fixed rate is exchanged to a non-fixed occupancy time of a resource, the occupancy of a resource may continue longer than expected by the administrator and result in excessive use of the resources in a non-optimal manner. When this occurs, other consuming services may contend with the occupying consuming service for access to the resource. Therefore, it is desirable to address this problem by optimizing the use of resources at least partially based on input by an administrator, and/or a weighted algorithm.

One particular example is that of customers in an establishment. Often customers remain at a venue, or establishment, after they have finished using services or activities of the venue, actively using resources. These customers occupy the resources such as tables, or physical space in the venue that could be used to serve new customers, which decreases profitability. Unfortunately, it can appear rude for restaurant personnel to ask, or suggest, lingering patrons leave the establishment and therefore these customers become the occupying consuming service and block other customers from accessing the resource, i.e., the table, the space or the like resulting in a lack of optimal access of resources.

To solve this problem, embodiments of the disclosure provide a method for offering incentives to occupying consuming services selected according to a weighted algorithm, based partially on input from an administrator of one or more resources. In one specific embodiment, the disclosure also provides an establishment, or restaurant, an opportunity to nudge seated customers, who are finished with their meal, to get an incentive to “turn their table”. To “turn the table” indicates that the table has been freed and allows for reservation systems to work in an enhanced manner without delay, improving queue line management technology, improving bottlenecks in the waiting area, improving faster table turnover compared to handheld buzzers, pagers, light up devices, and other notification devices.

The present disclosure describes enhancing table seating efficiencies during both busy and slow times. This novel turnover technology helps shape customer behavior by optimizing restaurant traffic and frequency, increasing customer satisfaction, and building customer loyalty through a platform, as described herein.

One embodiment of the disclosure describes allowing restaurants to offer incentives via secure, seamless, and subtle suggestions (i.e., nudges) to help turn restaurant tables during busy times and or fill tables/bring in customers through incentives during slow times. Embodiments of this disclosure work for all formal seating restaurants (FSR), quick seating restaurants (QSR), family-owned, casual-chain, and fine-dining restaurants, indoor or outdoor seating, and other dining and food services venues.

As described herein, one embodiment may be an on demand cloud computing platform or API (application program interface) or other suitable interface that is provided to individuals, companies, and governments on a pay-as-you-go basis.

An API is a set of routines, protocols, and tools for building software applications. An API specifies how software components should interact. Additionally, APIs are used when programming graphical user interface (GUI) components. A well-crafted API makes it easier to develop a program by providing all the building blocks. A programmer then puts the blocks together.

Another platform may be an AMAZON™ Web Service (AWS) cloud-based, Software-as-a-Service (SaaS), or any suitable platform with the requisite storage and processing capability, technology embodiment that maximizes table seating efficiencies during both busy and slow times. This platform can run on web based and mobile devices, offering a user-friendly interface to voluntarily nudge customers finished with their meals to help turn tables during busy times, and nudge customers at home to come to the restaurant during slow times. In return, the restaurant can offer an incentive to the customer for leaving (restaurant chosen dollar or percentage or coupon). The incentive to customers at home (discounts, free food, menu items, coupons) can be used during restaurant slow times to build loyalty.

As described herein, the AWS cloud-based, SaaS platform may be used to interact and communicate with customers who are at the restaurant or who are not at the restaurant. The AWS cloud-based, SaaS platform works with an identifier such as QR codes, or other suitable code, which may be black and white, a bar code pattern or other suitable code pattern, that incentivizes the seated customer by 1) allowing for a secure, seamless, and subtle restaurant-customer experience; 2) helping family-owned, casual-chain, and fine-dining restaurants improve business; 3) working for indoor or outdoor dining restaurants.

Some embodiments help to bring customers to the venue on slow nights by offering an incentive to customers at home (discounts, free food, menu items, coupons) based on a set of criteria such as one or more of customer location, customer history, entity sales history, local, national and global trends or the like. Some embodiments may also be used during restaurant slow times to build loyalty. Such embodiments may be implemented on a variety of platforms, including cloud platforms such as AWS™, AZURE™, GOOGLE CLOUD™, or the like.

Embodiments include coupons that are embedded with a QR code to help capture data and metrics that can track customers and campaign incentives and provides operators access to those coupons and provide campaign management so operators can determine which campaigns are working more effectively than others.

Restaurants have increasingly become an essential part of people's lifestyles, as rising income levels, healthier food options, variety of cuisines, need for social gatherings and celebrations, increase the desire for people to dine outside of their homes. There are over 1 million US restaurants that employ close to 15.6 million people, about 10% of the US workforce. The restaurants themselves are divided into two main categories: 1) QSR, or quick serve restaurants, which provide fast food seating, drive through, or delivery, and 2) FSR, or full service restaurants, which provide sit down seating, menu table service, take out, or delivery.

These FSR restaurants (full service restaurants) are typically chain restaurants that have multiple locations throughout the US, and number over 500,000; the remaining FSR restaurants are independent restaurants (many family-owned) at 490,000, and fine dining restaurants close to 5,000.

Restaurants usually measure their sales metrics through one or more of three variables: 1) the sales volume per restaurant, 2) number of guests count (either QSR or FSR), and 3) the average check amount.

Embodiments described herein enhance the customer experience and facilitate management of customer flow in a restaurant, or any venue that provides a service to customers, such as an amusement park, concert, bar, nightclub, ski resort, ice skating rink, swimming pool, museum, airports, amusement parks, doctor's office, live events, mall parking lot, gym, entertainment venue, or other suitable venue, event or location.

Embodiments of the disclosure include, for example, a cloud-based, SaaS platform that uses QR codes to initiate incentive-based nudges for seated customers securely and subtly.

The embodiments disclose resource optimization, such as a table turnover that helps restaurants improve the bottom line by increasing the number of patrons served in a given time period. Restaurants have fixed costs (same amount of rent, minimum staffing for the kitchen and floor, etc.) that restaurant management considers for the daily operations, and the variables mentioned before, such as increase in sales, more customers, and/or an increase in the average check, all contribute to profitability.

Embodiments described herein provide access to a resource to as many people as possible in a given time frame, specifically those resources that have a fixed cost regardless of usage time. This is achieved by providing consumers of a resource an incentive to free-up the resource for another consumer. This incentive includes reduced costs for a later occupancy of the resource, such as a scheduler that creates an occupancy schedule for services that still need the resource.

For example, when the entity is a restaurant, the fixed costs stay the same no matter how many customers dine at the restaurant. Embodiments described herein facilitate restaurants turning more tables daily, with a choice of incentive, thereby improving profitability. The embodiments described do not rush customers, but rather, gives customers a choice to help decide if the customer would like to get a benefit in return for turning their table for waiting customers. The benefit may be a discount from the bill, such as a percentage, a coupon for a future visit, parking voucher, or other reward for compliance with the incentive offer.

The embodiments of the disclosure help existing reservation systems become more timely, and increase customer satisfaction, even improve ratings and reviews at restaurants to bring in more customers, and overall satisfaction of being seated more quickly or being seated close to the estimated seating time the customer was given. This helps restaurants with their table turnover and restaurants can schedule their resources more appropriately for that day's service.

Indeed, embodiments are directed to a cloud-based, SaaS Platform that uses QR codes to initiate incentive-based nudges, or incentive notifications, for customers, who may be seated at a table. Participating restaurants can provide table management data and seating capacity on the platform via web based or mobile devices. When restaurants are busy, restaurant management can send a request to one or more seated customers inquiring if the customer is interested in the platform and bring a pre-loaded incentive via a QR code on a device to them or already provided at the table. The seated customer has the right to accept or decline the incentive via their own personal mobile device. If accepted, the seated customer receives a benefit, such as an instant price reduction of the bill or a return visit coupon and receives a time departure on their mobile device to leave the restaurant within a time period.

The disclosure describes a cloud-based, SaaS Platform that uses QR codes and text messages to initiate incentive-based nudges that provide a benefit, such as discounts, free food, menu items, coupons, or other rewards, to consumers who are not at the venue and the management of the venue seeks to attract more consumers. These consumers may include individuals who are at home and the night may be a slow night, or a time when the venue is at less than full capacity.

Participating restaurants enter their coupon or campaign management, or other incentive, including a benefit and an constraint, on the platform via web based or mobile devices. The consumer at home has the right to accept or decline the incentive via a consumer mobile device. If accepted, the consumer at home receives and brings the incentive to redeem at the venue, such as a restaurant. These coupons and campaign management are embedded with a QR code to help capture data and metrics that will give operators access to those coupons and campaign management are working more efficiently than others. The data and analytics provide information that is extremely helpful to the management of the venue.

Many popular US and worldwide restaurants have long wait times to get a table, especially during social gatherings such as special family occasions, consumer-client business meetings, holidays and observances, date nights. Some of these restaurants offer reservations in advance, some of these restaurants offer time-based devices that buzz or light up or phone-text services to let consumers know when their table is ready. However, reservations sometimes overflow, and consumers still have to wait to get their table, even though consumers have arrived on time. Time-based devices and phone-text services are still based on the previous consumers that are already sitting in the restaurant who have not completed their meal or are still socializing. All of this tends to bottleneck the restaurant, both physically at whatever entrance the restaurant offers (foyer, lobby, street, etc.), as well as the actual table turnover efficiency.

It is not uncommon to see wait times delayed several minutes to even hours with the current consumer and restaurant situation to just get a table, not including the time to order and enjoy a meal. Often, the consumer walks away just seeing the bottleneck of consumers waiting for a table or walks away when the consumer asks the restaurant personnel how long the wait is. These consumers who leave represent lost revenue. Often, the restaurant will tell the consumer the wait time for when their table will be ready, but delays occur making the consumer experience unsatisfactory from the start. Restaurants that do not utilize reservation systems, time-based devices, phone-text services, etc. can be even more bottlenecked for waiting consumers. In today's social media world, that consumer can instantly post a negative comment about the prolonged wait time, which may damage the restaurant's reviews.

The need to improve restaurant table turnover efficiency will be paramount for consumers to have a satisfactory dining experience.

For example, consumers at venues that utilize embodiments as described herein can be notified upon arrival, or via the venue's website, that the venue utilizes incentives, as described herein and this means that there will be an opportunity for the restaurant to nudge seated consumers during busy times, so those seated consumers can get the benefit, such as a reduction of their bill or a return visit coupon, be able to finish their meal comfortably, and leave within time for another table to get ready.

Restaurants and venues that utilize these embodiments will improve their table turnover efficiency, reduce lost consumers who are waiting for tables, and have more flowable-volume of consumers, which will improve profitability. Thus, the embodiments described herein allow restaurants to efficiently turnover tables during busy times by offering incentives for turning over the table to the consumers (instead of lingering around after finishing the meal) and allows restaurants to ensure a consumer's second visit by offering discount that can be applied to a future visit.

One embodiment of the disclosure relates to table mapping. The table mapping allows restaurants to identify each of their tables uniquely. It creates a unique identity for each table, creating a unique system generated ID in the backend, allowing restaurants to assign user/staff friendly labels and tie both of those IDs to unique barcodes. This allows forming of incentive-based turnover strategies for each table individually.

Another embodiment of the disclosure relates to discount flexibility. Discount flexibility allows users, or customers, or consumers, to select types of discounts they would prefer as their potential benefit for complying. The discount flexibility benefit may include a percentage discount, or dollar discounts, or future dining options. Discount flexibility permits the restaurants to form a dual purpose strategy in which restaurants can provide discounts (for turning over the table) that can be used in the next visit, ensuring more revenue today, by way of serving more consumers on that table today, as well as in the future, by way ensuring consumers visit again, to utilize a next visit discount.

The incentive also includes an obligation, constraint, or requirement, that the consumer must complete to obtain the benefit. This constraint can be conveyed to the consumer via a synched timer between consumers' devices and restaurants' devices, or processors. Once a consumer agrees to comply with the constraint, which may be to leave the venue and thus, turnover the table, in a specified time period, such as 10 minutes and taking the benefit offered in return, the time period, such as a 10 minute countdown timer, keeps both parties up to date with the remaining time on hand. This timer can be a display on the consumer device and the restaurant management device.

The restaurant, or venue, can label, via a map, such as a seating map, their tables in their own way. The labeling permits the restaurant, or venue, to identify tables based on their own domain language in a unique way to provide management, such as the restaurant manager, the capability to nudge a party from their table. This nudge can include a benefit, such as an activate discount, for example, a dollar amount or percentage off the bill for either for this visit or upcoming visit, for that particular table.

The disclosure describes a system, method and apparatus that may be web based, which permits an application-like experience without the need for either party, restaurant, or consumer, to download an app to their mobile device. The disclosure establishes easy two-way-communication channels between restaurants and their consumers and enables creation of consumer accounts on-the-fly, or in real time, thus eliminating the need for consumers to carry specific devices, downloading apps, managing their storage spaces and app permissions to be able to receive table-turnover incentives from the restaurants and communicating back to the resource-provider, i.e., the restaurant, what they chose to do with the incentive.

One example of the disclosure includes a unique process-flow between an administrator, including venue personnel, such as a server at a restaurant, and a consuming service and/or a customer. The entity identifies a resource that is over-occupied and sends a machine readable code from a server to the consuming service occupying that resource, and the consuming service has an API that evaluates whether the code with the incentive is acceptable (based on their own metrics). In a restaurant example, a server requests a consumer to scan a barcode. Once a consumer scans the barcode, a message is sent to the consumer's device describing a current situation at the venue, such as a long wait for other consumers for a table at the restaurant. The barcode provides a full description of an incentive offered to the consumer.

The incentive includes a benefit, such as coupon or discount, and an associated constraint, such as leaving the venue within a per defined period of time. The consumer can accept or reject the benefit of the incentive. Acceptance of the benefit is also acceptance of the constraint. Thus, if a consumer accepts the benefit, the constraint is sent to the consumer. One example constraint is that the consumer will exit the venue in a predetermined window of time. This initiates a clock, or a timer, which can be represented as a clockface or hourglass icon displayed on the consumer's device. A corresponding display can be provided to a restaurant manager device, which can be synchronized in a cloud. If a discount is given, the discount is credited to consumer's created account. If the benefit is for a subsequent visit, the benefit is credited to the consumer's next visit.

As described, embodiments include a campaign management in which a unique campaign-coupon-consumer-restaurant linkage is generated. This allows resource-providers, such as owners and/or managers of venues to create sales campaigns via a process and linking each campaign to unique coupons, linking each coupon to unique consumers and linking each combination of campaign-coupon-consumer to a uniquely identifiable entity, such as a restaurant or other venue, as well as other consumer preferences. This process includes collecting data based on, inter alia, data points which is based on a consumer using a coupon, which creates a consumer profile, this use data can then be analyzed and used to form consumer profile patterns. These profile patterns provide insight to venues, such as restaurants for favorable benefits for users.

The data, incentives, benefits, constraints, timing, benefit amounts and other data can suitably be displayed on a graphical user interface (GUI) at a desired location such as a management device, customer or consumer device, or third party device. All of these devices can be considered a user device, as described herein. This GUI may be provided as a dashboard representation to a resource-provider, such as restaurant, that is unique, that shows utilizations of marketing strategy to the restaurant industry in a unique way. The benefit(s) may include a discount, a coupon, a, an advertisement, one or more points, a membership, a discounted rate, cash back, or products.

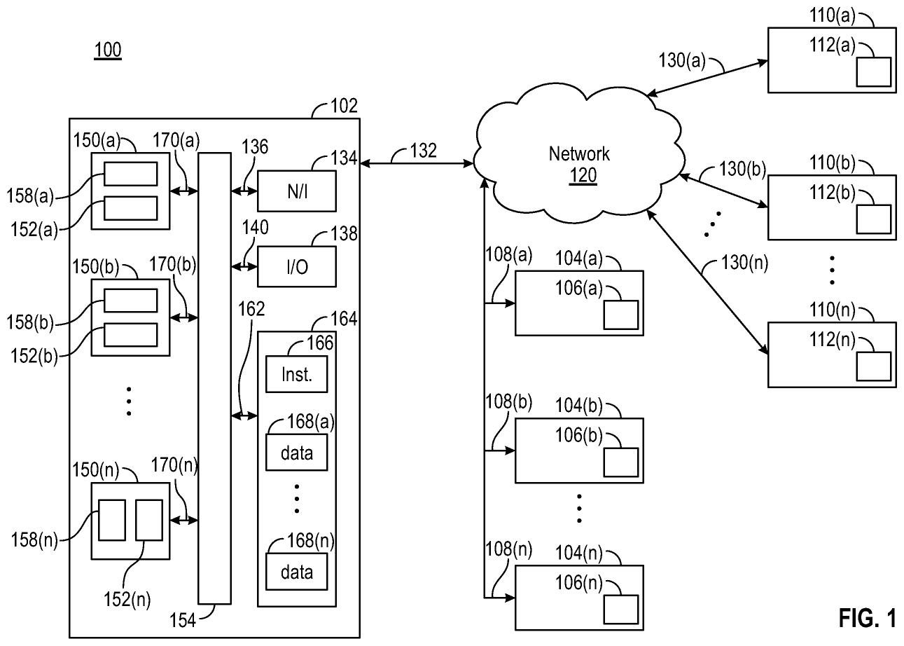

FIG. 1 shows a network environment of an embodiment of the disclosure. The environment 100 includes a computer 102, which may be a server, host, or other suitable processing device. Environment 100 also includes network 120, which may be any network of computing devices, the Internet, or other connected processing or storage devices. Venue devices 104(a) . . . (n), where “n” is any suitable number, and customer, or consumer devices 110(a) . . . (n), where “n” is any suitable number, are also shown. The venue devices 104(a) . . . (n), and/or the consumer devices/customer devices 110(a) . . . (n), are also referred to as user devices. For any system or system element discussed in the present disclosure, there can be additional, fewer, or alternative components arranged in similar or alternative orders, or in parallel. Although FIG. 1 illustrates a client-server network architecture, other embodiments may utilize other network architectures, such as peer-to-peer or distributed network environments,

FIG. 1 is a diagram that illustrates an exemplary computing system 100 in accordance with embodiments of the present disclosure. Various portions of systems and methods described herein, may include, or be executed on one or more computer systems similar to computing system 100. Further, processes and modules described herein may be executed by one or more processing systems similar to that of computing system 100.

FIG. 1 shows a computing system 102, network 120, venue devices 104(a) . . . (n), where “n” is any suitable number, and consumer devices 110(a) . . . (n), where “n” is any suitable number. Venue devices 104 and consumer devices 110 are both considered user devices, since data may be displayed at both venue devices 104 and consumer devices 110.

Computing system 102 includes one or more processors 150(a) . . . (n), where “n” is any suitable number, input/output interface 154, network interface 134, an input/output (I/O) device interface 138 and system memory 164. Computing system 102 is in bi-directional communication with cloud/network/Internet 120, via bi-directional wired or wireless channel 132, thereby providing and/or accessing data from those components. Computing system 102 may include a plurality of computing devices (e.g., distributed computer systems) to implement various processing functions.

Processors 150(a) . . . (n), where “n” is any suitable number (generally 150 herein), may include a single processor or a plurality of processors (e.g., distributed processors). Processor 150 may be any suitable processor capable of executing or otherwise performing instructions. Each processor 150(a) . . . (n) may include an associated central processing unit (CPU), or general or special purpose microprocessors, special purpose logic circuitry, e.g., an FPGA (field programmable gate array) or an ASIC (application specific integrated circuit) 152(a) . . . (n), where “n” is any suitable number, that carries out program instructions to perform the arithmetical, logical, and input/output operations of computing system 102. Each processor 150(a) . . . (n) may also include and associated processor memory 158(a) . . . (n), where “n” is any suitable number, adapted to store data the associated processor 150(a) . . . (n) may use.

Processors 150 may execute code (e.g., processor firmware, a protocol stack, a database management system, an operating system, or a combination thereof) that creates an execution environment for program instructions. Processor 150 may receive instructions and data from a memory (e.g., system memory 164, or a remote memory, via network 120). Multiple processors may be employed to provide for parallel or sequential execution of one or more portions of the embodiments described herein. Processes, such as logic flows, described herein may be performed by one or more programmable processors executing one or more computer programs to perform functions by operating on input data and generating corresponding output.

I/O interface 154 is operatively coupled to one or more processors 150(a) . . . (n) via associated bi-directional communication channel 170(a) . . . (n), where “n” is any suitable number, operatively coupled to network interface 134 via bi-directional communication channel 136, operatively coupled to I/O device interface 138 via bi-directional communication channel 140, operatively coupled to system memory 164 via bi-directional communication channel 162. The I/O interface 154 may be configured to coordinate I/O traffic between one or more processors 150(a) . . . (n), system memory 164, network interface 134, I/O device interface 138, and/or other peripheral devices (e.g., 104, 110) via network 120.

I/O interface 154 may perform protocol, timing, or other data transformations to convert data signals from one component (e.g., system memory 164) into a format suitable for use by another component (e.g., processors 150(a) . . . (n)).

I/O interface 154 may include support for devices attached through various types of peripheral buses, such as a variant of the Peripheral Component Interconnect (PCI) bus standard or the Universal Serial Bus (USB) standard.

The network interface 134, which is operatively coupled to I/O interface 154 via bi-directional communication channel 136, can operate as an interface between venue devices 104 and/or consumer devices 110 via network 120 via an instant messaging protocol (e.g., Extensible Messaging and Presence Protocol (XMPP), Open System for Communication in Realtime (OSCAR), Session Initiation Protocol for Instant Messaging and Presence Leveraging Extensions (SIMPLE), etc.) Network interface 134 may include a network adapter that provides for connection of computing system 102 to network 120. Network interface 134 may facilitate data exchange between computing system 102 and other devices, such as user devices (104, 110) connected to the network 120. Network interface 134 may support wired or wireless communication channels.

I/O device interface 138 may provide an interface for connection of one or more devices, such as venue devices 104, consumer devices 110 and/or other devices connected to network 120 and/or computing system 102.

System memory 164 is operatively coupled to I/O interface 154 via bi-directional channel 162. System memory 164 may be configured to store program instructions 166 and/or data in suitable storage medium 168(a) . . . (n), where “n” is any suitable number.

Program instructions 166 may be executable by a processor (e.g., one or more of processors 150(a) . . . (n)) to implement one or more embodiments. Program instructions 166 may include modules of computer program instructions for implementing one or more embodiments described herein with regard to various processing modules.

Program instructions 166 may include a computer program, which in certain forms is known as a program, software, software application, script, or code. A computer program may be written in a programming language, including compiled or interpreted languages, source code or object code, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 164 also includes memory data 168(a) . . . (n), where “n” is any suitable number, which may be a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like.

System memory 164 may include a non-transitory computer readable storage medium that may have program instructions stored thereon that are executable by a computer processor (e.g., one or more of processors 150(a) . . . (n)) to execute the processing and the functional operations described herein. A memory (e.g., system memory 164) may include a single memory device and/or a plurality of memory devices (e.g., distributed memory devices). The program, or instructions are an algorithm that identifies a resource and an associated capacity of the resource. The algorithm then calculates the optimal consumer use of the resource and the incentive to be offered to maximize the use or enjoyment of the resource by consumers. The algorithm may use machine learning and/or artificial intelligence to determine the optimal consumer capacity of a resource. Once the capacity and use are determined an appropriate nudge is generated. For example, on a Tuesday night at 7:00 pm, if a restaurant is only half full, the venue administrator can input the customer volume into a GUI at the venue device and the algorithm stored in memory 168, with processor 150 generates a nudge, such as 15 percent discount. If the restaurant is only 25% capacity, the algorithm could generate a nudge such as 20 percent discount. These nudges can be offered by venue personnel or transmitted electronically to consumers.

Embodiments described herein may be implemented using a single instance of computing system 102 or multiple computing systems 102 configured to host different portions of embodiments. Multiple computing systems 102 may provide for parallel or sequential processing/execution of one or more portions of the embodiments described herein.

Cloud, or Internet, or network 120 is any suitable network of computers, processing devices, output devices, severs, or processors that provide bi-directional communication between computer system 102 and other devices, shown as venue devices 104(a) . . . (n) and consumer devices 110(a) . . . (n), via bi-directional communication channels 108(a) . . . (n) and 130(a) . . . (n), where “n” is any suitable number, respectively. These bi-directional communication channels 108, 130, as well as other communication channels may be wired or wireless communication. The network 120 may include an electronic communication network, such as the Internet, a local area network (LAN), a wide area network (WAN), a cellular communications network, or the like.

The network 120 may include an Internet Protocol (IP) network via hypertext transfer protocol (HTTP), secure HTTP (HTTPS), and the like. The network 120 may also support an e-mail server configured to operate as an interface between clients and the network components over the IP network via an email protocol (e.g., Simple Mail Transfer Protocol (SMTP), Internet Message Access Protocol (IMAP), Post Office Protocol (POP), etc.).

Venue devices 104(a) . . . (n), where “n” is any suitable number, may be situated at a venue, such as a restaurant, or other location. Venue devices 104 are also referred to as user devices since data and information may be processed and displayed at the device 104. The venue devices 104, generally, may include a computer, smart phone, tablet, laptop, processor, and the venue devices 104 may also include input device(s) and graphical user interface (GUI) 106(a) . . . (n), where “n” is any suitable number, presented on displays (e.g., a cathode ray tube (CRT) or liquid crystal display (LCD) monitor).

The input devices, not shown, may include pointing devices (e.g., a computer mouse or trackball), keyboards, keypads, touchpads, scanning devices, voice recognition devices, gesture recognition devices, printers, audio speakers, microphones, cameras, or the like.

The venue devices 104(a) . . . (n) can operate any of a wide variety of desktop or server operating systems (e.g., Microsoft Windows, Linux, UNIX, Mac OS X, etc.), mobile operating systems (e.g., Apple iOS, Google Android, Windows Phone, etc.), or other operating systems or kernels.

Consumer devices, also referred to as consumer devices and also referred to as user devices, 110(a) . . . (n), where “n” is any suitable number, may be smart phones, laptops, tablets, or other suitable processing and display device. Consumer, or customer devices 110 are also referred to as user devices since data and information may be processed and displayed at the device 110. The customer devices, or consumer devices, or user devices, 110 may include, for example, graphical user interface (GUI) 112(a) . . . (n), where “n” is any suitable number, presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like.

The consumer devices 110 can execute web browsers, e-mail clients, chat clients, instant messengers, SMS clients, social network applications, and other stand-alone applications for communicating with the network 120.

The consumer devices 110 can operate any of a wide variety of desktop or server operating systems (e.g., Microsoft Windows, Linux, UNIX, Mac OS X, etc.), mobile operating systems (e.g., Apple iOS, Google Android, Windows Phone, etc.), or other operating systems or kernels.

Those skilled in the art will appreciate that environment 100 is merely illustrative and is not intended to limit the scope of the embodiments described herein. Computing system 102 may include any combination of devices or software that may perform or otherwise provide for the performance of the embodiments described herein.

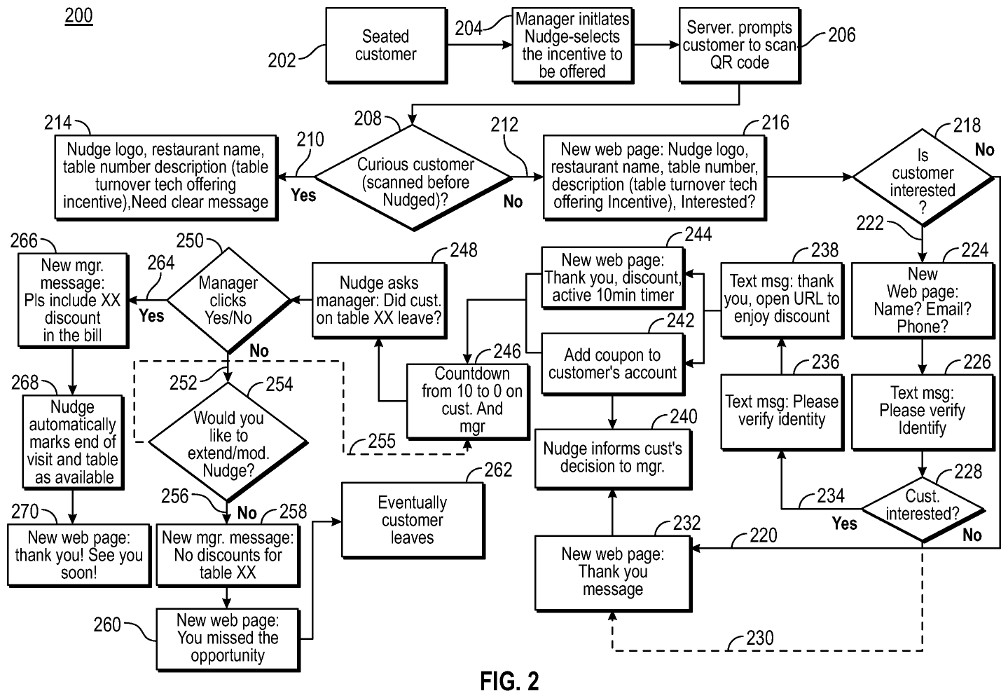

FIG. 2 shows an example of a process 200 according to an embodiment of the disclosure. The process 200 is performed by a venue device, having a GUI communicating with a customer device, also referred to as a consumer device, having a GUI to perform a transaction of offering an incentive to a consumer, or customer. The consumer accepts the incentive and confirms that the consumer complies with the constraint and the venue properly credits the customer.

The process 200 begins with an indication of a seated customer 202 at a venue, such as a restaurant. A manager, or other venue personnel initiates a nudge, by selecting an incentive to be offered 204. The server, or other restaurant personnel prompts the customer to scan a QR code 206. The customer, to whom the incentive was offered, may also scan the QR code prior to the server prompting the customer to determine whether the customer may be interested in an incentive, 208.

If the customer is interested in an incentive, “yes” 210 shows that the incentive details are provided to the customer, 214. If the customer does not scan the QR code of their own initiative, “no” 212 shows that incentive details are provided to the customer 216.

A customer can decide whether he/she is interested in the incentive, 218. If the customer indicates that he/she is not interested in the incentive, “no” 220 shows that a new web page is displayed to the customer, 232. This webpage shows that a “Thank You” message, or other message may be displayed at the customer device, indicating that the venue has received the non-acceptance message from the customer.

If the customer indicates that he/she is interested in the incentive, “yes” 222 shows that a new web page is displayed to the customer, 224. This webpage may obtain customer information such as name, email address, phone number, and provide details regarding the incentive, including the benefit and the constraint, or other relevant information, 224.

A text message, or other communication, may be sent to the customer device to verify the customer's identity, 226.

A customer can indicate whether he/she is interested in the incentive and accepts the incentive, 228.

If the customer indicates that he/she does not accept the incentive, “no” 230 shows that a new web page is displayed to the customer, 232. This webpage shows that a “Thank You” message, or other message may be displayed, at the customer device, indicating that the venue has received the message from the customer.

If the customer is interested, “yes” 234 shows that a message is sent to the customer device to confirm the customer's identity, 236.

The benefit information is provided to the customer device, 238. The constraint data, such as a ten minute time window is provided to the customer, 244. Also, a coupon may be added to the customer's account, 242.

Information regarding the customer's decision is provided to the venue personnel, such as a manager, 240. This information may also be provided as shown by 232 leading to 240.

Once the benefit has been credited to the customer, 242 and the constraint, such as a time for the customer to leave, 244 have been completed, the countdown for compliance with the constraint begins, 246.

A message, or other communication is provided to venue device(s), or venue personnel, to confirm that the customer has complied with the constraint, 248. The venue, or restaurant personnel can determine whether the customer has complied with the constraint, or not, 250.

If the venue, or restaurant personnel, confirms that the customer has complied with the constraint, “yes” 264 shows that the benefit is confirmed to the customer, 266 and the space, or table, in the venue is updated to indicate it is available, 268 and a confirmatory message is displayed at either or both of the venue device and/or the customer device, 270.

Referring back to the venue, or restaurant personnel determining whether the customer has complied with the constraint, or not, 250, if the venue, or restaurant personnel indicate that the customer has not complied with the constraint, “no” 252 shows that the venue, or restaurant personnel has an option to modify the conditions, such as extending the time, for compliance, 254.

If the conditions are modified, “yes” 255 shows that a new constraint is initiated, such as starting a second time period for compliance, 246.

If the conditions are not modified, “no” 256 shows that a message is generated by a remote device or the venue device indicating the benefit for the customer has been revoked, 258. A message is provided to the customer device(s) indicating that the benefit has been revoked 260. Eventually, the customer will leave the establishment, or venue 262.

As shown in FIG. 2, an embodiment of the disclosure describes a plurality of opportunities, as shown by 218, 228, for a customer to review the particular details of an incentive, including the benefit and the constraint, prior to accepting the terms and conditions of the incentive.

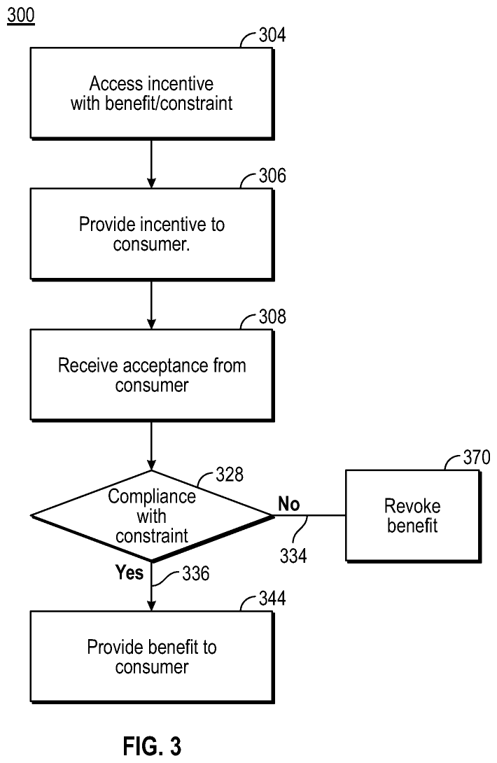

FIG. 3 shows an example embodiment 300 of the disclosure. The process 300 of FIG. 3 may be stored on a suitable electronic medium, as described herein, including non-transitory storage media. The process 300 includes accessing one or more incentives 304. Each incentive having an associated benefit and constraint. The process of FIG. 3 applies to any optimization of any resource that consumers may wish to use or participate. While an example of tables at a restaurant is one embodiment that is useful to explain the concepts, the concepts apply to natural resources, individuals time, manufacturing or any suitable environment that can be optimized by incentivizing consumers to enable other consumers to utilize the resource.

The incentive(s), including the benefit(s) and constraint(s) are provided to a consumer, 306.

An affirmative response to the incentive is received from the consumer to the venue personnel, 308.

A determination is made whether the consumer has complied with the constraint, 328.

If the consumer has complied with the constraint, “yes” 336 shows the benefit is provided to the consumer, 344.

If the consumer has not complied with the constraint, “no” 334 shows that the benefit is revoked from the consumer, 370.

The sequence of events can vary based on type of restaurants and local customs etc. As an example, the below sequence of events is common across the country. (The order is in reverse.)
T1=Timestamp to leave the restaurant.
T2=Timestamp to Complete Eating.
T3=Timestamp to deliver food to table.
T4=Timestamp to have order from consumer.
T5=Timestamp to provide menu to consumer.
T6=Timestamp to be seated.
T7=Timestamp of consumer arrival.
Tn=Timestamp for some event.

The embodiments described herein generate a nudge, which provides methods to trigger signals for the hosts if the time spent between events exceeds an average time defined or automatically determined in the system. The signals are derived from the average time spent between events. Below is one simplified version of an example scenario.
T_{Done}=Timestamp when all the parties/consumers have completed eating their respective ordered food on the table Tc.
T_{Leave}=Timestamp when all the parties/consumers leave the table TC.

When T_{Done}+NOW>average time spent by consumers on the table after complete eating food AND (Number of consumers waiting to be seated is non-zero OR Expected number of consumers who reserved tables are more than available tables) THEN trigger the signal for the hosts to offer incentives using the platform, as described herein.

The following is an example of calculating an increase in revenue using nudge technology:
Cc1—Consumer 1 (Group).
Cn1=Total number of persons in Consumer 1
Cov1=Consumer #1 offer value.
Ctr1=Consumer #1 revenue (bill).
Cnp1=Consumer #1 net profit excluding offer.
Cnrp1=Consumer #1 net realized profit including offer.

### Example

Consumer group with 3 individuals
Cc . . . +Cn . . . =30 min avg time on table without using nudge
Cc . . . +Cn . . . =$100 avg revenue
Cc . . . +Cn . . . =30 min+10 min if . . .
$100−$33=$67 (Net realized revenue) ($33 lost).

There are n number of ways to trigger nudge signals, but the outcome is to improve the revenue for each resource provider with optimal use of resources, such as tables during busy hours or slow hours.

Number of consumers served using nudge>number of consumers without using nudge
1. Time spent on table without nudge>time spent on table using nudge
2. Revenue/Table or Revenue/consumer without using nudge<Revenue/Table or Revenue/Consumer using nudge
3. When time taken by consumer is greater than average time for the food ordered and consumed, the platform as described herein will trigger the signal and create a nudge.

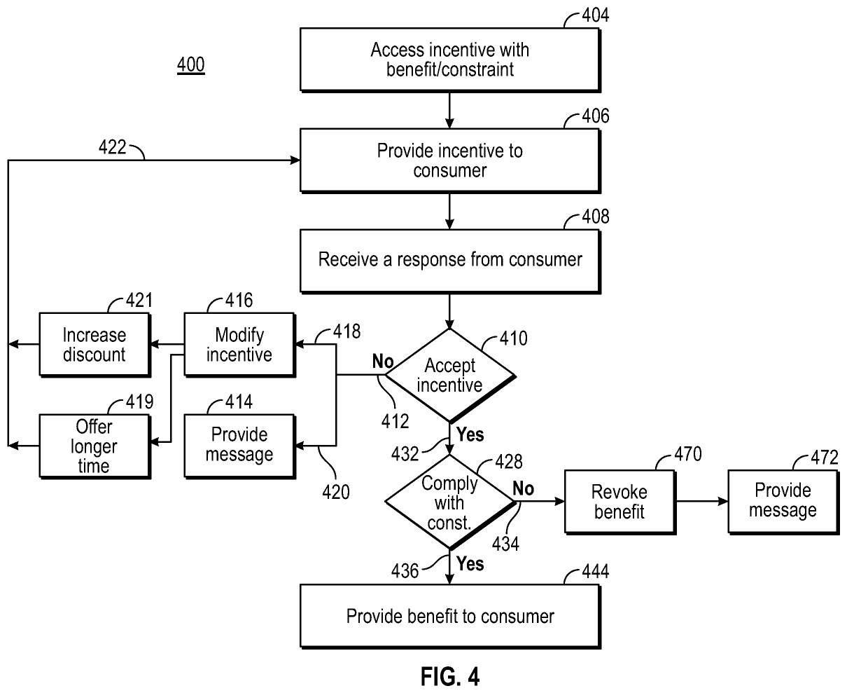

FIG. 4 shows another example embodiment 400 of the disclosure. The process 400 of FIG. 4 may be stored on a suitable electronic medium, as described herein, including non-transitory storage media. The process 400 includes accessing one or more incentives 404. Each incentive having an associated benefit and constraint.

The incentive(s), including the benefit(s) and constraint(s) are provided to a consumer, 406.

A response to the incentive is received from the consumer to the venue personnel, 408.

The consumer can choose to accept the incentive, 410. If the consumer does not accept the incentive, “no” 412, with portion 418, shows that the incentive can be modified, 416, or “no” portion 420 shows that a message can be provided to the consumer device indicating the incentive was not accepted by the consumer, 414.

If the incentive is modified, 416, the modification could be to increase the amount of the discount 421, and/or extend the time required to leave the venue, 419. Line 422 shows that the modified incentive is provided, by the resource provider, to the consumer 406. This modification process (416, 422, 406) can repeat until the consumer agrees to a modified incentive, or the venue can decide that no further modified incentives will be offered. Once no further modifications are being offered by the resource-provider, line 420 shows that a message is provided to the consumer device indicating that the incentive was not accepted, 414.

If the consumer accepts the incentive, “yes” 432 shows that a determination is made whether the consumer has complied with the constraint, 428.

If the consumer has complied with the constraint, “yes” 436 shows the benefit is provided to the consumer, 444.

If the consumer has not complied with the constraint, “no” 434 shows that the benefit is revoked from the consumer, 470 and a message is provided to the consumer device indicating that the benefit has been revoked, 472.

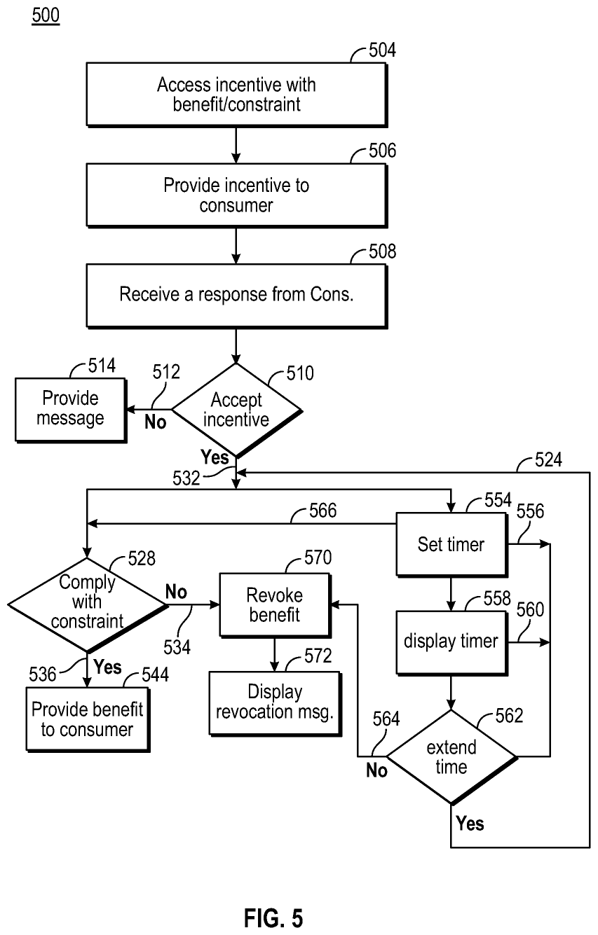

FIG. 5 shows another example embodiment 500 of the disclosure. The process 500 of FIG. 5 may be stored on a suitable electronic medium, as described herein, including non-transitory storage media. The process 500 includes accessing one or more incentives 504. Each incentive having an associated benefit and constraint.

The incentive(s), including the benefit(s) and constraint(s) are provided to a consumer, 506.

A response to the incentive is received from the consumer to the venue personnel, 508.

The consumer can choose to accept the incentive, 510. If the consumer does not accept the incentive, “no” 512 shows that a message can be provided to the consumer device indicating the incentive was not accepted by the consumer, 514.

If the incentive is accepted by the consumer 510, “yes” 532 shows that a timer is set, 554 and a representation of the timer is displayed, 558. Line 560 shows that the timer indicating the time is adjusted based on a possible time extension, 562. The representation of the timer may be displayed at either or both of the consumer device(s) and/or venue device(s). Generally, the consumer devices and venue devices may be user devices.

Once the timer is set, the elapsed time is determined, line 566 shows that a determination is made whether the consumer is in compliance with the constraint 528.

If the time for compliance elapses, line 556 shows that the time for compliance may be extended, 562. If the time is extended, “yes” 524 shows that the timer is reset and/or compliance determination 528 is determined by resetting the timer, 554.

If the time for compliance is not extended, “no” 564 shows that the benefit to the consumer is revoked, 570. A representation of the revocation of the benefit is provided at either or both of the venue device and/or the consumer device 572.

Referring to acceptance of the incentive, 510, a determination is made whether the consumer has complied with the constraint, 528. This may be either the original time set or the modified time.

If the consumer has complied with the constraint, “yes” 536 shows the benefit is provided to the consumer, 544.

If the consumer has not complied with the constraint, “no” 534 shows that the benefit is revoked from the consumer, 570. A representation of the revocation of the benefit is provided at either or both of the venue device and/or the consumer device 572.

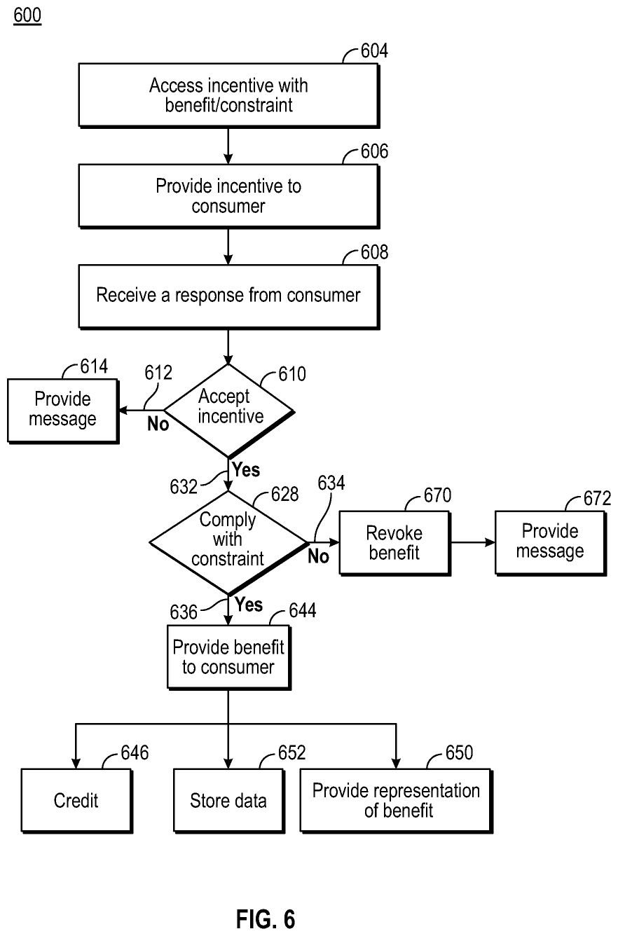

FIG. 6 shows another example embodiment 600 of the disclosure. The process 600 of FIG. 6 may be stored on a suitable electronic medium, as described herein, including non-transitory storage media. The process 600 includes accessing one or more incentives 604. Each incentive having an associated benefit and constraint.

The incentive(s), including the benefit(s) and constraint(s) are provided to a consumer, 606. The benefit may include a discount, and/or a coupon and/or an upgrade, which is provided to the consumer. The type of benefit offered is any suitable benefit that the venue management, or other party chooses to offer.

A response to the incentive is received from the consumer to the venue personnel, 608.

The consumer can choose to accept the incentive, 610. If the consumer does not accept the incentive, “no” 612, shows that a message can be provided to the consumer device indicating the incentive was not accepted by the consumer, 614.

If the incentive is accepted by the consumer 610, “yes” 632 shows that a determination is made whether the consumer is in compliance with the constraint 628.

If the consumer has complied with the constraint, “yes” 636 shows the benefit is provided to the consumer, 644. The granting of the benefit may include providing an immediate discount or credit, 646, and/or storing data related to a future credit, which may include an indication of the benefit in a consumer account, 652 and/or providing a representation of the benefit to the consumer device 650.

If the consumer has not complied with the constraint, “no” 634 shows that the benefit is revoked from the consumer, 670. A representation of the revocation of the benefit is provided at either or both of the venue device and/or the consumer device 672.

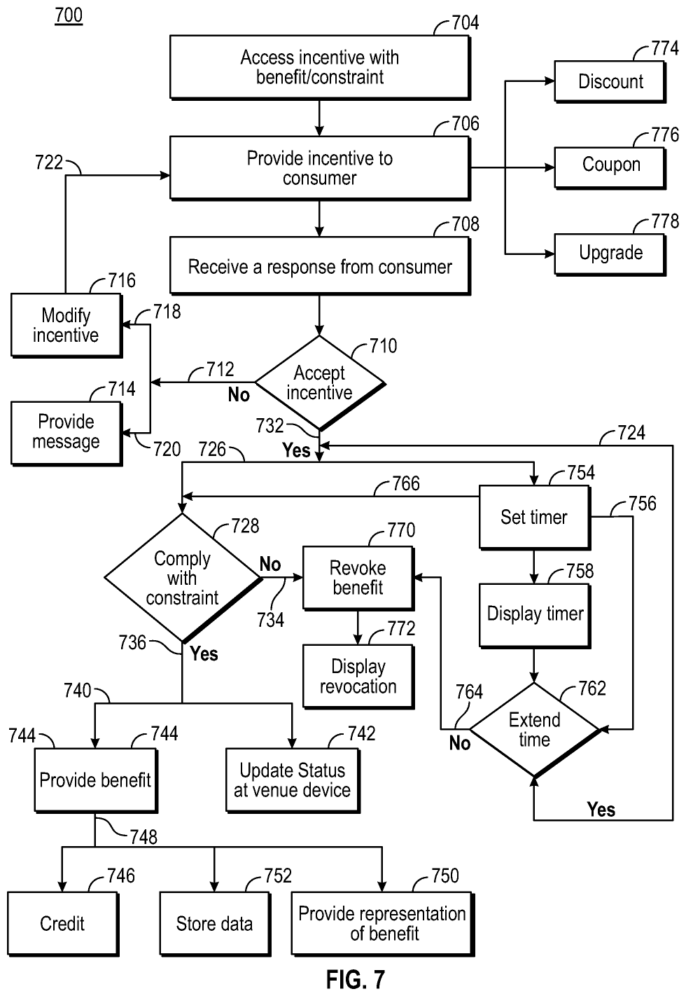

FIG. 7 shows another example embodiment 700 of the disclosure. The process 700 of FIG. 7 may be stored on a suitable electronic medium, as described herein, including non-transitory storage media. The process 700 includes accessing one or more incentives 704. Each incentive having an associated benefit and constraint.

The incentive(s), including the benefit(s) and constraint(s) are provided to a consumer, 706. The benefit may include a discount, 774, a coupon 776 and/or an upgrade 778, which is provided to the consumer, once the completion of the obligation, or constraint, has been verified. This verification may be executed at a remote location, such as computing device 102, as shown and described herein.

A response to the incentive is received from the consumer to the venue personnel, 708.

The consumer can choose to accept the incentive, 710. If the consumer does not accept the incentive, “no” 712, with portion 718, shows that the incentive can be modified, 716, or “no” portion 720 shows that a message can be provided to the consumer device indicating the incentive was not accepted by the consumer, 714.

If the incentive is modified, 716, line 722 shows that the modified incentive is provided to the consumer 706. This can repeat until the consumer agrees to a modified incentive, or the resource provider can decide that no further modified incentives will be offered. Once no further modifications are offered, refusal to accept the incentive 712, generates message showing incentive was declined, 714

If the incentive is accepted by the consumer 710, “yes” 732 shows that a timer is set, 754 and a representation of the timer is displayed, 758. The representation of the timer may be displayed at either or both of the consumer device(s) and/or venue devices.

Once the timer is set, the elapsed time is determined, line 766 shows that a determination is made whether the consumer is in compliance with the constraint 728.

If the time for compliance elapses, line 756 shows that the time for compliance may be extended, 762. If the time is extended, “yes” 724 shows that the timer is reset and/or compliance determination 728 is determined.

If the time for compliance is not extended, “no” 764 shows that the benefit to the consumer is revoked, 770. A representation of the revocation of the benefit is provided at either or both of the venue device and/or the consumer device 772. As shown by “yes” 736 from compliance with constraint 728, an update of the resource availability is provided at a venue device. Thus, the previously occupied, or used resource, such as a restaurant table, is indicated as available for another consumer.

Referring to acceptance of the incentive, 710, a determination is made whether the consumer has complied with the constraint, 728.

If the consumer has complied with the constraint, “yes” 736 shows the benefit is provided to the consumer, 744. The granting of the benefit may include providing an immediate discount or credit, 746, and/or storing data related to a future credit, which may include an indication of the benefit in a consumer account, 752 and/or providing a representation of the benefit to the consumer device 750.

If the consumer has not complied with the constraint, “no” 734 shows that the benefit is revoked from the consumer, 770. A representation of the revocation of the benefit is provided at either or both of the venue device and/or the consumer device 772.

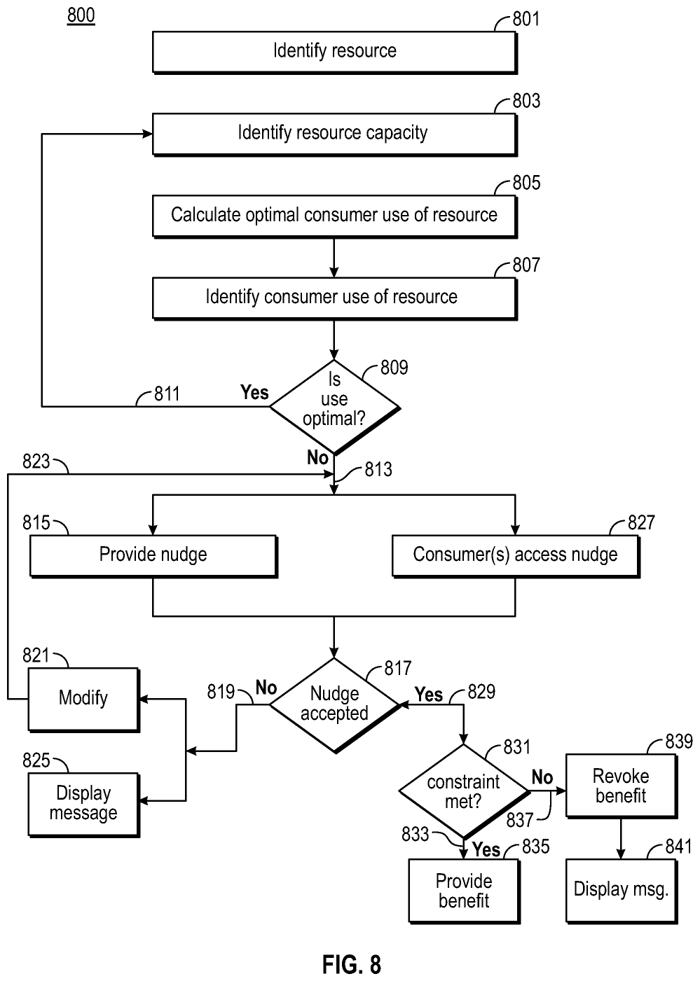

FIG. 8 shows an embodiment of resource optimization for consumers. The process 800 of FIG. 8 may be stored on a suitable electronic medium, as described herein, including non-transitory storage media. A resource is identified, 801. This resource may be any product, article, good or service. This includes natural resources, as well as time spent in an establishment and/or service offered by an entity. The capacity of the resource is identified, 803. This includes the quantity of the resource, demand for the resource, future demand for the resource, occupancy limits for a venue and other metric that indicates how available the resource is or is forecasted to be.

The optimal consumer use of the resource is calculated, 805. This calculation can be the result of a mathematical algorithm, statistical analysis, market trends, or similar data points. This algorithm may be stored in the memory locations (168(a) . . . (n)), or other suitable memory that may be store or displayed on a user device, such as a venue device and/or consumer device.

A current, or forecasted, consumer use of the identified resource is determined, 807.

A determination is made, based on the capacity of the resource, optimal use of the resource and consumer use of the resource whether the use is optimal, 809. If so, “yes” 811 shows the resource capacity 803, optimal use, 805 and consumer use of the resource, 807 are identified.

If the consumer use of the resource is not optimal, 809, “no” 813 shows that either one or both f providing a nudge to one or more consumers 815 and/or one or more consumers accessing a nudge 827 can occur. The nudge will indicate a benefit and an associated constraint.

Regardless of the process of a consumer being informed of a nudge (815, 827) a determination is made whether the consumer accepts the nudge, 817.

If the consumer accepts the nudge, 817, “yes” 829 shows that a determination is made whether the constraint is met, 831. If the constraint is met, “yes” 833 shows that the benefit is provided to the consumer, 835.

If the constraint is not met, “no” 837 shows that the benefit is revoked, 839 and a message to that effect is provided to the consumer, 841.

Referring back to a consumer not accepting a nudge, 817, “no” 819 shows that the nudge may be modified, 821 and the modified nudge can be presented, 823, to a consumer either by being provided, 815 and/or accessed, 827.

Once a nudge is not accepted, whether modified, or the original nudge, a message is displayed to a user device so indicating, 825. The user device may be a resource-provider device (104) and/or a consumer device (110).

The functions performed in the processes and methods described above may be implemented in differing order. Furthermore, the outlined steps and operations are only provided as examples. Some of the steps and operations may be optional, combined into fewer steps and operations, or expanded into additional steps and operations without detracting from the disclosed embodiments' essence.

Some embodiments of the disclosure may be described as a system, method, apparatus, or computer program product. Accordingly, embodiments of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in one or more computer readable storage media, such as a non-transitory computer readable storage medium, having computer readable program code embodied thereon.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together but may comprise disparate instructions stored in different locations which, when joined logically, or operationally, together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. The system or network may include non-transitory computer readable media. Where a module or portions of a module are implemented in software, the software portions are stored on one or more computer readable storage media, which may be a non-transitory media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing, including non-transitory computer readable media.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray Disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals.

In the context of this disclosure, a computer readable storage medium may be any tangible medium that can contain or store a program for use by or in connection with an instruction execution system, apparatus, or device.

Program code for carrying out operations for aspects of the present disclosure may be generated by any combination of one or more programming language types, including, but not limited to any of the following: machine languages, scripted languages, interpretive languages, compiled languages, concurrent languages, list-based languages, object oriented languages, procedural languages, reflective languages, visual languages, or other language types.

The program code may execute entirely on the computing device, partly on the venue computer, and/or partly on the consumer's device. It may act as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Although the following detailed description contains many specifics for the purposes of illustration, anyone of ordinary skill in the art will appreciate that many variations and alterations to the following details are within the scope of the disclosure. Accordingly, the following embodiments are set forth without any loss of generality to, and without imposing limitations upon, the claims.

In this detailed description, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present disclosure.

Furthermore, in this detailed description, a person skilled in the art should note that quantitative qualifying terms such as “generally,” “substantially,” “mostly,” “approximately” and other terms are used, in general, to mean that the referred to object, characteristic, or quality constitutes a majority of the subject of the reference. The meaning of any of these terms is dependent upon the context within which it is used, and the meaning may be expressly modified.

Some of the illustrative embodiments of the present disclosure may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the disclosure has been described with reference to exemplary embodiments, it will be understood by those skilled in the art that various changes may be made, and equivalents may be substituted for elements thereof without departing from the scope. In addition, many modifications may be made to adapt a particular situation or material to the teachings without departing from the essential scope thereof.

Therefore, it is intended that the disclosure not be limited to the particular embodiment disclosed as the best or only mode contemplated for carrying out this disclosure, but that the disclosure will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation, the scope of the disclosure therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items. Thus, the scope of the disclosure should be determined by the appended claims and their legal equivalents, and not by the examples given.

Embodiments, as described herein can be implemented using a computing system associated with a transaction device, the computing system comprising: a non-transitory memory storing instructions; and one or more hardware processors coupled to the non-transitory memory and configured to execute the instructions to cause the computing system to perform operations. Additionally, a non-transitory machine-readable medium having stored thereon machine-readable instructions executable to cause a machine to perform operations may also be used.

One example embodiment is a computer-implemented method for optimizing resources, the method comprising: using at least one hardware processor for executing code for: accessing one or more incentives, the incentives including a benefit and a constraint providing one or more incentives to one or more consumers via an associated consumer device; receiving, via the associated consumer device, a response from the one or more consumers to the incentive; in response to receiving an affirmative response, determining compliance with the constraint by the consumer; in response to determining compliance with the constraint, providing the benefit to the consumer; and causing a representation of the provided benefit to be displayed on the consumer device.

Another embodiment is directed to the computer-implemented method described above, further comprising determining a consumer interest level associated with the incentive.

Another embodiment is directed to the computer-implemented method described above, further comprising modifying the incentive based at least in part on the consumer interest level.

Another embodiment is directed to the computer-implemented method above further comprising in response to receiving a negative response, from the one or more consumers to the incentive, generating a representation of the negative response; and causing the representation of the negative response to be displayed on a user device.

Another embodiment is directed to the computer-implemented method described above, further comprising determining non-compliance with the constraint; in response to determining non-compliance with the constraint, revoking the benefit to the consumer; and causing a representation of the revoked benefit to be displayed on a user device.

Another embodiment is directed to the computer-implemented method described above, further comprising updating a status of a resource to available upon compliance with the constraint; and in response to the update, causing a representation of the status to be displayed at a user device

Another embodiment is directed to the computer-implemented method described above, further comprising correlating a time period for compliance with the constraint; and causing a representation of the time period to be displayed on a user device.

Another embodiment is directed to the computer-implemented method described above, further comprising correlating a time period for compliance with the constraint; determining a decrease in the time period; and causing a representation of the decreasing time period to be displayed on a consumer device.

Another embodiment is directed to the computer-implemented method described above, further comprising determining non-compliance with the constraint based at least in part on a time for compliance with the constraint expiring; in response to determining non-compliance with the constraint, revoking the benefit to the consumer; and causing a representation of the revoked benefit to be displayed on the consumer device.

Another embodiment is directed to the computer-implemented method described above, further comprising: correlating a time period for compliance with the constraint; causing a representation of the time period to be displayed on a consumer device; extending the time period for compliance with the constraint; and causing a representation of the extended time period to be displayed on a consumer device.

Another embodiment is directed to the computer-implemented method described above, wherein the one or more benefits comprise at least one of a discount, a coupon, an advertisement, one or more points, a membership, a discounted rate, cash back, or products.

Another embodiment is directed to the computer-implemented method described above, further comprising resource mapping to allow identification of each resource.

Another embodiment is directed to a system for optimizing resources, comprising: one or more memories configured to store representations of data in an electronic form; and one or more processors, operatively coupled to one or more of the memories, the processors configured to access the data and process the data to: access one or more incentives, the incentives including a benefit and a constraint provide one or more incentives to one or more consumers via an associated consumer device; receive, via the associated consumer device, a response from the one or more consumers to the incentive; determine, in response to receiving an affirmative response, compliance with the constraint by the consumer; provide, in response to determining compliance with the constraint, the benefit to the consumer; and cause a representation of the provided benefit to be displayed on the consumer device.

Another embodiment is directed to a system for optimizing resources described above, wherein the processors are further configured to access the data and process the data to: determine a consumer interest level associated with the incentive.

Another embodiment is directed to a system for optimizing resources described above, wherein the processors are further configured to access the data and process the data to: modify the incentive based at least in part on the consumer interest level.

Another embodiment is directed to a system for optimizing resources described above, wherein the processors are further configured to access the data and process the data to: generate, in response to receiving a negative response from the one or more consumers to the incentive, a representation of the negative response; and cause the representation of the negative response to be displayed on a user device.

Another embodiment is directed to a system for optimizing resources described above, wherein the processors are further configured to access the data and process the data to: determine non-compliance with the constraint; revoke the benefit to the consumer, in response to determining non-compliance with the constraint; and cause a representation of the revoked benefit to be displayed on a user device.

Another embodiment is directed to a system for optimizing resources described above, wherein the processors are further configured to access the data and process the data to: update a status of a resource to available upon compliance with the constraint; and cause a representation of the status to be displayed at a user device in response to the update.

Another embodiment is directed to a system for optimizing resources described above, wherein the processors are further configured to access the data and process the data to: correlate a time period for compliance with the constraint; and cause a representation of the time period to be displayed on a user device.

Another embodiment is directed to a system for optimizing resources described above, wherein the processors are further configured to access the data and process the data to: correlate a time period for compliance with the constraint; determine a decrease in the time period; and cause a representation of the decreasing time period to be displayed on a consumer device.

Another embodiment is directed to a system for optimizing resources described above, wherein the processors are further configured to access the data and process the data to: determine non-compliance with the constraint based at least in part on a time for compliance with the constraint expiring; revoke the benefit to the consumer in response to determining non-compliance with the constraint; and cause a representation of the revoked benefit to be displayed on the consumer device.

Another embodiment is directed to a system for optimizing resources described above, wherein the processors are further configured to access the data and process the data to: correlate a time period for compliance with the constraint; cause a representation of the time period to be displayed on a consumer device; extend the time period for compliance with the constraint; and cause a representation of the extended time period to be displayed on a consumer device.

Another embodiment is directed to a system for optimizing resources described above, wherein the processors are further configured to access the data and process the data to: map each resource to allow identification of each resource.

Another embodiment is directed to a non-transitory machine-readable medium having stored thereon machine-readable instructions executable to cause a machine to perform operations comprising: access one or more incentives, the incentives including a benefit and a constraint, provide one or more incentives to one or more consumers via an associated consumer device; receive, via the associated consumer device, a response from the one or more consumers to the incentive; determine, in response to receiving an affirmative response, compliance with the constraint by the consumer; provide, in response to determining compliance with the constraint, the benefit to the consumer; and cause a representation of the provided benefit to be displayed on the consumer device.

Another embodiment is directed to the non-transitory machine-readable medium described above, wherein the operations further comprise: determine a consumer interest level associated with the incentive.

Another embodiment is directed to the non-transitory machine-readable medium described above, wherein the operations further comprise: modify the incentive based at least in part on the consumer interest level.

Another embodiment is directed to the non-transitory machine-readable medium described above, wherein the operations further comprise: generate, in response to receiving a negative response from the one or more consumers to the incentive, a representation of the negative response; and cause the representation of the negative response to be displayed on a user device.

Another embodiment is directed to the non-transitory machine-readable medium described above, wherein the operations further comprise: determine non-compliance with the constraint; revoke the benefit to the consumer, in response to determining non-compliance with the constraint; and cause a representation of the revoked benefit to be displayed on a user device.

Another embodiment is directed to the non-transitory machine-readable medium described above, wherein the operations further comprise: update a status of a resource to available upon compliance with the constraint; and cause a representation of the status to be displayed at a user device in response to the update.

Another embodiment is directed to the non-transitory machine-readable medium described above, wherein the operations further comprise: correlate a time period for compliance with the constraint; and cause a representation of the time period to be displayed on a user device.

Another embodiment is directed to the non-transitory machine-readable medium described above, wherein the operations further comprise: correlate a time period for compliance with the constraint; determine a decrease in the time period; and cause a representation of the decreasing time period to be displayed on a consumer device.

Another embodiment is directed to the non-transitory machine-readable medium described above, wherein the operations further comprise: determine non-compliance with the constraint based at least in part on a time for compliance with the constraint expiring; revoke the benefit to the consumer in response to determining non-compliance with the constraint; and cause a representation of the revoked benefit to be displayed on the consumer device.

Another embodiment is directed to the non-transitory machine-readable medium described above, wherein the operations further comprise: correlate a time period for compliance with the constraint; cause a representation of the time period to be displayed on a consumer device; extend the time period for compliance with the constraint; and cause a representation of the extended time period to be displayed on a consumer device.

Another embodiment is directed to the non-transitory machine-readable medium described above, wherein the operations further comprise: map each resource to allow identification of each resource.

It will be appreciated by those skilled in the art that changes could be made to the various aspects described above without departing from the broad inventive concept thereof. It is to be understood, therefore, that the subject application is not limited to the particular aspects or exemplary embodiments disclosed, but it is intended to cover modifications within the spirit and scope of the subject application as defined by the appended claims.

1. A computer-implemented method for optimizing resources, the method comprising:
using at least one hardware processor for executing code for:
based on a metric corresponding to utilization of resources between consumers and a service provider, providing data corresponding to an incentive to a consumer via an associated consumer device, the incentive including a monetary benefit to the consumer and a constraint that is operative to make available at least one of the resources for another consumer;
in response to receiving an affirmative response from the consumer via the associated consumer device, determining data indicating compliance with the constraint by the consumer; and
in response to the data indicating compliance with the constraint, causing a graphical representation of the monetary benefit to be displayed on the associated consumer device.

2. The computer-implemented method of claim 1, further comprising: determining a consumer interest level associated with the incentive.

3. The computer-implemented method of claim 2, further comprising: modifying the incentive based at least in part on the consumer interest level.

4. The computer-implemented method of claim 1, further comprising:
in response to receiving a negative response, from the consumer to the incentive, generating a representation of the negative response; and
causing a representation of the negative response to be displayed on a user device.

5. The computer-implemented method of claim 1, further comprising:
determining non-compliance with the constraint;
in response to determining non-compliance with the constraint, revoking the monetary benefit to the consumer; and
causing a representation of the revoked monetary benefit to be displayed on a user device.

6. The computer-implemented method of claim 1, further comprising:
updating a status of a resource to indicate that the resource is available upon compliance with the constraint; and
in response to the update, causing a representation of the status to be displayed at the associated consumer device.

7. The computer-implemented method of claim 1, further comprising:
correlating a time period for compliance with the constraint; and
causing a representation of the time period to be displayed on the associated consumer device.

8. The computer-implemented method of claim 1, further comprising:
correlating a time period for compliance with the constraint;
determining a decrease in the time period; and
causing a representation of the decreasing time period to be displayed on the associated consumer device.

9. The computer-implemented method of claim 1, further comprising:
determining non-compliance with the constraint based at least in part on a time for compliance with the constraint expiring;
in response to determining non-compliance with the constraint, revoking the monetary benefit to the consumer; and
causing a representation of the revoked monetary benefit to be displayed on the associated consumer device.

10. The computer-implemented method of claim 1, further comprising:
correlating a time period for compliance with the constraint;
causing a representation of the time period to be displayed on the associated consumer device;
extending the time period for compliance with the constraint; and
causing a representation of the extended time period to be displayed on the associated consumer device.

11. The computer-implemented method of claim 1, wherein the one or more benefits comprise at least one of a discount, a coupon, an advertisement, one or more points, a membership, a discounted rate, cash back, or products.

12. The computer-implemented method of claim 1, further comprising resource mapping to allow identification of each resource.

13. A system for optimizing resources, comprising:
one or more memories configured to store graphical representations of data in an electronic form; and
one or more processors, operatively coupled to one or more of the memories, the processors configured to:
based on a metric corresponding to utilization of resources between consumers and a service provider, provide data corresponding to an incentive to a consumer via an associated consumer device, the incentive including a monetary benefit to the consumer and a constraint that is operative to make available at least one of the resources for another consumer;
determine, in response to receiving an affirmative response, data indicating compliance with the constraint by the consumer; and
in response to the data indicating compliance with the constraint, cause a graphical representation of the benefit to be displayed on the associated consumer device.

14. The system of claim 13, wherein the processors are further configured to access the data and process the data to:
determine a consumer interest level associated with the incentive.

15. The system of claim 14, wherein the processors are further configured to access the data and process the data to:
modify the incentive based at least in part on the consumer interest level.

16. The system of claim 13, wherein the processors are further configured to access the data and process the data to:
generate, in response to receiving a negative response from the one or more consumers to the incentive, a representation of the negative response; and
cause the representation of the negative response to be displayed on a user the associated consumer device.

17. The system of claim 13, wherein the processors are further configured to access the data and process the data to:
determine non-compliance with the constraint;
revoke the monetary benefit to the consumer, in response to determining non-compliance with the constraint; and
cause a representation of the revoked monetary benefit to be displayed on the associated consumer device.

18. The system of claim 13, wherein the processors are further configured to access the data and process the data to:
update a status of a resource to indicate that the resource is available upon compliance with the constraint; and
cause a representation of the status to be displayed at the associated consumer device in response to the update.

19. The system of claim 13, wherein the processors are further configured to access the data and process the data to:
determine non-compliance with the constraint based at least in part on a time for compliance with the constraint expiring;
revoke the monetary benefit to the consumer in response to determining non-compliance with the constraint; and
cause a representation of the revoked monetary benefit to be displayed on the associated consumer device.

20. A non-transitory machine-readable medium having stored thereon machine-readable instructions executable to cause a machine to perform operations comprising:
based on a metric corresponding to utilization of the resources between consumers and a service provider, provide data corresponding to an incentive to a consumer via an associated consumer device, the incentive including a monetary benefit to the consumer and a constraint that is operative to make available at least one of the resources for another consumer;
determine, in response to receiving an affirmative response, data indicating compliance with the constraint by the consumer; and
in response to the data indicating compliance with the constraint, cause a graphical representation of the monetary benefit to be displayed on the associated consumer device.
